(19) United States
(12) Patent Application Publication
(10) Pub. No.: US 2026/0065933 A1
(43) Pub. Date: Mar. 5, 2026

(54) MAGNETIC RECORDING MEDIUM PRODUCTION METHOD

(71) Applicant: Resonac Hard Disk Corporation, Chiba (JP)

(72) Inventors: Shoko UETAKE, Chiba (JP); Gohei KUROKAWA, Chiba (JP); Kazuki SHINDO, Chiba (JP); Koshiro YOSHIYAMA, Chiba (JP); Yoshihiko MARUYAMA, Chiba (JP); Ayumi YAMAKAWA, Chiba (JP)

(21) Appl. No.: 19/302,502

(22) Filed: Aug. 18, 2025

(30) Foreign Application Priority Data
Aug. 30, 2024 (JP) 2024-149993

(51) Int. Cl. G11B 5/725; G11B 5/84

(52) U.S. Cl. CPC G11B 5/7257; G11B 5/8408

(57) ABSTRACT

A magnetic recording medium production method, which includes forming a lubricating layer over a stack including a substrate, a magnetic recording layer over the substrate, and a protective layer over the magnetic recording layer, includes applying a first lubricant and a second lubricant to the stack; burnishing, with an abrasive, a surface of the stack to which the first lubricant and the second lubricant are applied; and removing the second lubricant over the stack. The burnishing includes abrading the surface of the stack by pressing a tape containing the abrasive against the surface of the stack. The removal of the second lubricant includes irradiating the stack, to which the first lubricant and the second lubricant are applied, with light emitted from an LED light source.

### CROSS-REFERENCE TO RELATED APPLICATIONS

The present application is based on and claims priority to Japanese Patent Application No. 2024-149993 filed on Aug. 30, 2024, the entire contents of which are hereby incorporated by reference.

### BACKGROUND

### 1. Field of the Invention

The present disclosure relates to a magnetic recording medium production method.

### 2. Description of the Related Art

In recent years, magnetic storage devices are provided in various products, such as personal computers, video recorders, data servers, and the like, and the importance of the magnetic storage devices is increasing. The magnetic storage device includes a magnetic recording medium configured to store electronic data recorded through magnetic recording, and is, for example, a hard disk drive (HDD).

A typical magnetic recording medium has, for example, a multilayer stack structure. This multilayer stack structure is formed by sequentially forming a base layer, an intermediate layer, a magnetic recording layer, and a protective layer over a non-magnetic substrate, and applying a lubricating layer to the surface of the protective layer. The protective layer and the lubricating layer are provided for preventing durability of the magnetic recording medium from lowering due to abrasion caused by sliding of the magnetic recording medium in contact with a magnetic head. A hard carbon film is typically used as the protective layer. The lubricating layer is formed by applying a perfluoropolyether compound liquid or the like to the surface of the protective layer.

For enhancing a binding force of the lubricating layer to the protective layer, various treatments are performed on the lubricating layer. For example, Japanese Laid-Open Patent Application Publication No. 1999-25452 discloses a method of heating an applied lubricating layer, and further irradiating the heated lubricating layer with light using an ultraviolet lamp.

Also, for removing foreign matter and projections from the surface of the protective layer, tape burnishing is performed on the surface of the magnetic recording medium using an abrasive tape. Here, for preventing tape burnishing from forming scratches at the surface of the protective layer, tape burnishing is performed after formation of the lubricating layer.

Japanese Laid-Open Patent Application Publication No. 2002-222519 discloses a magnetic recording medium production method including forming a protective layer, applying a first lubricant free of an end group to a surface of the protective layer, performing tape burnishing on the surface of the protective layer, removing the first lubricant with a solvent, and applying a second lubricant having an end group to the surface of the protective layer.

### SUMMARY

The present disclosure provides the following.
[1] A magnetic recording medium production method which includes forming a lubricating layer over a stack including a substrate, a magnetic recording layer over the substrate, and a protective layer over the magnetic recording layer, the magnetic recording medium production method including:
applying a first lubricant and a second lubricant to the stack;
burnishing, with an abrasive, a surface of the stack to which the first lubricant and the second lubricant are applied; and
removing the second lubricant over the stack, wherein
the burnishing includes abrading the surface of the stack by pressing a tape containing the abrasive against the surface of the stack, and
the removal of the second lubricant includes irradiating the stack, to which the first lubricant and the second lubricant are applied, with light emitted from an LED light source.
[2] The magnetic recording medium production method according to [1], wherein
a center wavelength of the light emitted from the LED light source is less than 500 nm, and
the center wavelength of the light does not include a wavelength range of 170 nm to 190 nm.
[3] The magnetic recording medium production method according to [1] or [2], wherein
the irradiation of the stack with the light emitted from the LED light source is performed under a pressure close to an atmospheric pressure.
[4] The magnetic recording medium production method according to any one of [1] to [3], wherein
an average molecular weight of the first lubricant is higher than an average molecular weight of the second lubricant, and
polarity of the first lubricant is higher than polarity of the second lubricant.
[5] The magnetic recording medium production method according to [4], wherein
the average molecular weight of the second lubricant is 300 to 1,000, and
the second lubricant includes two or fewer polar groups, and does not include polar groups.
[6] The magnetic recording medium production method according to [4], wherein
the average molecular weight of the first lubricant is 900 to 3,000, and
the first lubricant includes four to eight polar groups.
[7] The magnetic recording medium production method according to any one of [1] to [6], wherein
a film thickness of the first lubricant applied to the stack is 5 angstroms to 10 angstroms, and
a film thickness of the second lubricant applied to the stack is 5 angstroms to 20 angstroms.

### BRIEF DESCRIPTION OF THE DRAWINGS

FIG. 1 is a cross-sectional diagram illustrating an example of a magnetic recording medium produced by a magnetic recording medium production method according to an embodiment of the present disclosure.

FIG. 2 is a diagram illustrating an example of an outline of the magnetic recording medium production method according to the embodiment of the present disclosure.

FIG. 3 is an enlarged cross-sectional diagram illustrating an example of a tape containing an abrasive used for burnishing.

FIG. 4 is a diagram illustrating an example of a burnishing apparatus used in a burnishing step of burnishing the surface of a stack with an abrasive.

FIG. 5 is a cross-sectional schematic diagram illustrating an example of an LED light irradiator used for production of a magnetic recording medium.

FIG. 6 is a perspective schematic diagram illustrating an example of a light source of the LED light irradiator.

### DETAILED DESCRIPTION OF THE DISCLOSURE

In the production of magnetic recording media, by performing tape burnishing after formation of the lubricating layer, formation of scratches or the like can be reduced by the effect of lubricity of the lubricating layer. However, in accordance with, for example, a type of lubricant used for the lubricating layer and a film thickness of the lubricating layer, tape burnishing may be unsuitable.

As in the magnetic recording medium production method of Japanese Laid-Open Patent Application Publication No. 2002-222519, it is conceivable to perform a treatment with a first lubricant suitable for tape burnishing, remove the first lubricant, and apply a second lubricating layer suitable for a magnetic recording medium. However, in this case, there are the following issues to address. Specifically, contaminants, lubricants, and the like dissolved into a solvent used for removal of the lubricant are attached to a treatment substrate, causing foreign matter at the surface of the magnetic recording medium. Also, it is challenging to completely remove the lubricant bonded to the protective layer using a solvent, and the remaining solvent causes foreign matter at the surface of the magnetic recording medium. This lowers a lubricating layer covering rate of the surface of the magnetic recording medium, and complicates a production process of the magnetic recording medium.

One aspect of the present disclosure has been made in diagram of the above issues. It is an object of the present disclosure to provide a magnetic recording medium production method that can efficiently remove foreign matter at the surface of a magnetic recording medium, and can produce a magnetic recording medium having a lubricating layer covering rate that is high.

Hereinafter, embodiments of the present disclosure will be described in detail with reference to the drawings. For facilitating understanding of the description, the same components in the drawings are indicated by the same symbols, and duplicate description thereof is appropriately omitted. Also, dimensional proportions of the components in the drawings are not necessarily the same as in reality. In the present specification, a numerical range indicated by “A to B” refers to a numerical range including a lower limit “A” and an upper limit “B”, unless otherwise specified. In the numerical range indicated by “A to B”, when only the upper limit A is indicated in units, the lower limit B is indicated in the same units.

Hereinafter, a magnetic recording medium production method according to the embodiment of the present disclosure will be described. A magnetic recording medium produced by the magnetic recording medium production method according to the present embodiment will be described.

### <Magnetic Recording Medium>

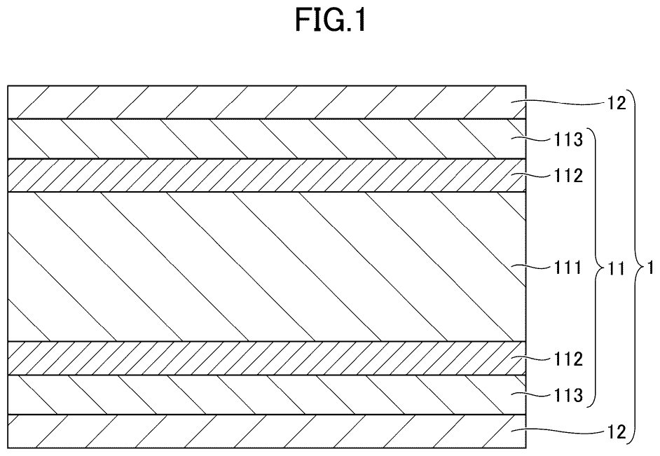

FIG. 1 is a cross-sectional diagram illustrating an example of the magnetic recording medium produced by the magnetic recording medium production method according to the present embodiment. As illustrated in FIG. 1, a magnetic recording medium 1 includes lubricating layers 12 formed respectively over both surfaces of a stack 11.

The stack 11 includes magnetic recording layers 112 formed respectively over both surfaces of a substrate 111, and protective layers 113 formed respectively over the magnetic recording layers 112.

The substrate 111 is formed of a non-magnetic material. The substrate 111 for use may be, for example, a metal substrate formed of a metal material, such as an aluminum alloy or the like. Alternatively, the substrate 111 for use may be, for example, a non-metal substrate formed of a non-metal material, such as glass or the like. In addition, an NiP alloy layer may be formed over the surface of the metal substrate or the non-metal substrate, for example, through plating or sputtering.

The magnetic recording layer 112 is provided for recording and reproducing information. For example, the magnetic recording layer 112 is provided for storing data by reversing the direction of magnetization by magnetic energy supplied from a magnetic head of an HDD, and maintaining the state of the resulting magnetization.

The magnetic recording layer 112 is formed of an FePt-based alloy having an L1₀ structure, a CoPt-based alloy having an L1₀ structure, a CoCrPt-based alloy having an hcp structure, or the like.

The magnetic recording layer 112 can be formed using a publicly known method, such as sputtering, ion beam deposition, or the like.

The protective layer 113 is provided for suppressing corrosion of the magnetic recording layer 112, for protecting the surface of the magnetic recording medium 1 by preventing damage to the surface of the magnetic recording medium 1 when the magnetic head contacts the magnetic recording medium 1, and for enhancing corrosion resistance of the magnetic recording medium 1.

The protective layer 113 can be formed of a well-known material, such as a hard carbon film formed of diamond-like carbon (DLC) or the like.

The protective layer 113 can be formed using a publicly known method, such as sputtering, ion beam deposition, or the like.

The surface of the protective layer 113 may be hydrogenated (allowed to contain hydrogen atoms) or nitrogenated (allowed to contain nitrogen atoms). By hydrogenating or nitrogenating the surface of the protective layer 113, it is possible to increase a binding force of the protective layer 113 to the lubricating layer 12 to be formed over the surface of the protective layer 113. That is, a first lubricant to be applied to the protective layer 113 has polarity, and thus forms strong bonds to hydrogen atoms and nitrogen atoms at the surface of the protective layer 113. Especially, the surface of the protective layer 113 is preferably nitrogenated.

The lubricating layer 12 is provided for suppressing abrasion of the magnetic head and the surface of the magnetic recording medium 1 when the magnetic head contacts the magnetic recording medium 1, and for enhancing corrosion resistance of the magnetic recording medium 1.

The thickness of the lubricating layer 12 is preferably 5 angstroms (Å) to 10 angstroms (Å). When the thickness of the lubricating layer 12 is 5 Å to 10 Å, it is possible to suppress abrasion of the surface of the magnetic recording medium 1 to enhance corrosion resistance of the magnetic recording medium 1, and reduce the distance between the magnetic head and the magnetic recording medium 1 in the HDD to realize a high recording density.

### <Magnetic Recording Medium Production Method>

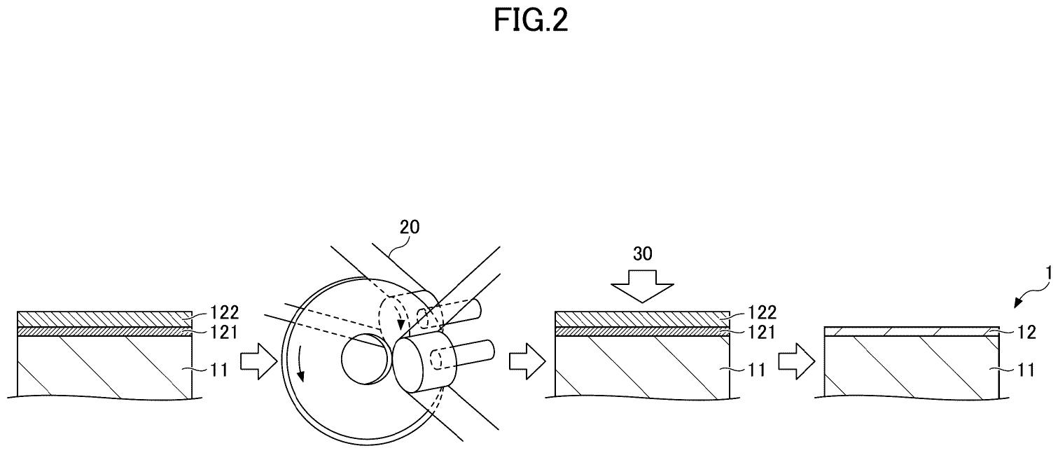

FIG. 2 is a diagram illustrating an example of an outline of the magnetic recording medium production method according to the present embodiment. As illustrated in FIG. 2, the magnetic recording medium production method according to the present embodiment includes forming the stack 11 (stack formation step), applying a first lubricant 121 and a second lubricant 122 to the stack 11 (application step), burnishing, with an abrasive, a surface of the stack 11 to which the first lubricant 121 and the second lubricant 122 are applied (burnishing step), and removing the second lubricant 122 from the stack 11 (removal step). The burnishing step includes abrading the surface of the stack 11 by pressing a tape containing the abrasive (abrasive tape) 20 against the surface of the stack 11 (abrasion step). The removal step includes irradiating the stack 11, to which the first lubricant 121 and the second lubricant 122 are applied, with light emitted from an LED light source (which may be referred to as “LED light”) 30 (LED light irradiation step).

The magnetic recording medium production method according to the present embodiment may include other steps, such as, for example, forming an adhesion layer, a soft magnetic base layer, a seed layer, or an orientation control layer between the substrate 111 and the magnetic recording layer 112. Also, when a plurality of the magnetic recording layers 112 are stacked, the magnetic recording medium production method according to the present embodiment may include, for example, forming a non-magnetic recording layer between the magnetic recording layers 112.

According to the magnetic recording medium production method according to the present embodiment, the first lubricant 121 and the second lubricant 122 are applied to the surface of the stack 11, and then the surface of the stack 11 is burnished with the abrasive. Subsequently, the second lubricant 122 over the stack 11 is removed by irradiating the second lubricant 122 over the stack 11 with the LED light 30 emitted from the LED light source. As a result, the first lubricant 121 remains at the surface of the protective layer 113 of the stack 11, and the remaining first lubricant 121 becomes the lubricating layer 12 of the magnetic recording medium 1, thereby forming the lubricating layer 12.

In the present embodiment, the LED light 30 emitted from the LED light source is used for removal of the second lubricant 122. As described above, removal of the lubricant used in the burnishing step has been performed through washing with a solvent. However, according to the studies conducted by the present inventors, it was found that the solvent used for the washing contained not only the removed lubricant but also contaminants generated in the burnishing, and this solvent remained at the surface of the protective layer 113, a surface to be washed, for a while. Re-attachment of the remaining contaminants, lubricant, and the like to the protective layer 113 was clearly found to be a cause for foreign matter at the surface of the magnetic recording medium 1. Also, completely removing the lubricant bonded to the protective layer 113 through washing with a solvent was challenging, and the slightly remaining lubricant was clearly found to be a cause for foreign matter at the surface of the magnetic recording medium 1.

In the present embodiment, the removal of the second lubricant 122 over the stack 11 is performed through a dry process of irradiation with the LED light 30 emitted from the LED light source. Therefore, the second lubricant 122 or the contaminants dissolved in the second lubricant 122 are quickly gasified and separated from the surface of the stack 11. Thus, these do not become a cause for foreign matter at the surface of the magnetic recording medium 1. Also, when irradiation conditions of the LED light 30 emitted from the LED light source are set to conditions in which the second lubricant 122 can be gasified, the second lubricant 122 over the stack 11 can be completely removed. Further, formation of the lubricating layer 12 is simplified, and thus it is possible to provide a magnetic recording medium production method having high productivity.

### [Stack Formation Step]

According to the magnetic recording medium production method according to the present embodiment, first, as illustrated in FIG. 1, the stack 11 including: the magnetic recording layers 112 formed respectively over both surfaces of the provided substrate 111; and the protective layers 113 formed respectively over the magnetic recording layers 112 is formed (stack formation step).

The stack 11 can be formed using a typical film-forming method for the magnetic recording layers 112 and the protective layers 113.

First, the magnetic recording layers 112 are formed respectively over both surfaces of the substrate 111. The formation of the magnetic recording layers 112 can be performed using a typical film-forming method, such as sputtering or the like.

For the sputtering, a target containing a material forming the magnetic recording layers 112 can be used.

As the target containing the material forming the magnetic recording layers 112, it is possible to use an FePt-based alloy having an L1₀ structure, a CoPt-based alloy having an L1₀ structure, a CoCrPt-based alloy having an hcp structure, or the like.

As the sputtering, it is possible to use DC sputtering, DC magnetron sputtering, radio frequency (RF) sputtering, or the like.

When forming the magnetic recording layers 112, an RF bias, a DC bias, a pulsed DC, a pulsed DC bias, or the like may be used, if necessary.

As a reactive gas, an O₂ gas, an H₂O gas, an N₂ gas, or the like may be used.

The sputtering gas pressure is appropriately adjusted to optimize the properties of resulting layers, but is typically within a range of about 0.1 Pa to about 30 Pa.

Next, the protective layers 113 are formed over the magnetic recording layers 112. No particular limitation is imposed on a method for forming the protective layers 113. For example, it is possible to use a typical film-forming method, such as, for example, radio frequency-chemical vapor deposition (RF-CVD) in which a film is formed by decomposing a raw material gas of a hydrocarbon with a high-frequency plasma, ion beam deposition (IBD) in which a film is formed by ionizing a raw material gas with electrons emitted from a filament, or a filtered cathodic vacuum arc (FCVA) process in which a film is formed using a solid carbon target.

### [Application Step]

Next, as illustrated in FIG. 2, the first lubricant 121 and the second lubricant 122 are sequentially applied to both surfaces of the stack 11 (application step).

Both surfaces of the stack 11 refer to both main surfaces of the stack 11 to which the first lubricant 121 and the second lubricant 122 are to be applied. The first lubricant 121 and the second lubricant 122 may be applied to one of the main surfaces of the stack 11, and then to the other main surface of the stack 11. Alternatively, the first lubricant 121 and the second lubricant 122 may be simultaneously applied to both main surfaces of the stack 11.

When the first lubricant 121 is applied to the protective layer 113, ideally, the overall surface of the protective layer 113 is preferably covered by the first lubricant 121, but a portion of the surface of the protective layer 113 may remain without the first lubricant 121 applied thereto. In this case, the second lubricant 122 may be applied to the portion not covered by the first lubricant 121.

The average molecular weight of the first lubricant 121 is preferably higher than the average molecular weight of the second lubricant 122, and the polarity of the first lubricant 121 is preferably higher than the polarity of the second lubricant 122. Thus, when the second lubricant 122 is to be removed by the LED light 30 emitted from the LED light source in the LED light irradiation step of the removal step described below, the irradiation conditions of the LED light 30 for gasifying the second lubricant 122 without gasifying the first lubricant 121 can be readily selected.

Organic compounds used as the first lubricant 121 and the second lubricant 122 include, as functional groups, a hydroxy group, an amino group, an amide group, a carbonyl group, a carboxyl group, a cyano group, a phenyl group, a methyl group, or the like. Of these, the functional groups having polarity (polar groups) are a hydroxy group, an amino group, an amide group, a carbonyl group, a carboxyl group, and a cyano group.

The average molecular weight of the first lubricant 121 is preferably 900 to 3,000, and the first lubricant 121 preferably includes four to eight polar groups in the structural formula thereof. Thus, when the second lubricant 122 is to be removed by the LED light 30 emitted from the LED light source in the LED light irradiation step of the removal step described below, the irradiation conditions of the LED light 30 for gasifying the second lubricant 122 without gasifying the first lubricant 121 can be readily selected.

The average molecular weight of the second lubricant 122 is preferably 300 to 1,000, and the second lubricant 122 preferably includes two or fewer polar groups in the structural formula thereof or preferably does not include polar groups in the structural formula thereof. Thus, when the second lubricant 122 is to be removed by the LED light 30 emitted from the LED light source in the LED light irradiation step of the removal step described below, the irradiation conditions of the LED light 30 for gasifying the second lubricant 122 without gasifying the first lubricant 121 can be readily selected.

The polar groups contained in the first lubricant 121 and the second lubricant 122 are preferably a hydroxy group, an amide group, and a cyano group, with a hydroxy group being particularly preferable. When the first lubricant 121 and the second lubricant 122 have the above-described preferable polar groups, it is possible to allow the first lubricant 121 to be suitable for the lubricating layer 12 of the magnetic recording medium 1, and to allow the second lubricant 122 to be suitable for the burnishing of the surface of the stack 11. When performing the above-described irradiation with the light emitted from the LED light source, the effect of quickly removing the second lubricant 122 or the contaminants dissolved in the second lubricant 122 is enhanced. Also, the first lubricant 121 can remain on the stack 11, and the binding force between the protective layer 113 and the first lubricant 121 can be increased. Thus, it is possible to further remove foreign matter at the surface, and further increase the lubricating layer 12 covering rate of the magnetic recording medium 1.

The application of the first lubricant 121 and the second lubricant 122 can be performed by a publicly known method, such as dipping, spin coating, a vapor method, or the like. The dipping is a method of dipping the stack 11 in a lubricant solution, and then lifting the stack 11 at a constant speed, thereby forming a lubricant film on the surface of the stack 11. The spin coating is a method of applying a lubricant solution to the surface of the stack 11, and then rotating the stack 11 at a high speed for a predetermined time, thereby forming a lubricant film on the stack 11. The vapor method is a method of placing the stack 11 in a vacuum container, and introducing a lubricant gasified by heat into the vacuum container, thereby forming a lubricant film on the stack 11.

When the dipping or the spin coating is used for the application of the second lubricant 122, a solvent for dissolving the second lubricant 122 needs to be a solvent that does not dissolve the first lubricant 121, a solvent that does not readily dissolve the first lubricant 121, or a solvent that allows the film thickness of the first lubricant 121 to remain to a certain extent even if the solvent dissolves the first lubricant 121.

The first lubricant 121 forms the lubricating layer 12 of the magnetic recording medium 1. Therefore, the film thickness of the first lubricant 121 is preferably 5 Å to 10 Å from the viewpoints of suppressing abrasion of the surface of the magnetic recording medium 1, improving corrosion resistance of the magnetic recording medium 1, and reducing the distance between the magnetic head and the magnetic recording medium 1 in the HDD to realize a high recording density.

The film thickness of the second lubricant 122 is preferably 5 Å to 20 Å. The second lubricant 122 having the film thickness of 5 Å to 20 Å is suitable for burnishing the surface of the stack 11. Also, it is possible to remove the second lubricant 122 for a short time by irradiation with the light emitted from the LED light source, and thus improve productivity of the magnetic recording medium 1.

### [Burnishing Step]

Next, the surface of the stack 11 is burnished with an abrasive (burnishing step).

As illustrated in FIG. 2, the burnishing step includes the abrasion step of abrading the surface of the stack 11 by pressing the abrasive tape 20 against the surface of the stack 11. In the burnishing step, the abrasive tape 20 can be pressed against the surface of the stack 11 to abrade the surface of the stack 11. A burnishing method and a burnishing apparatus will be described in detail with reference to the drawings.

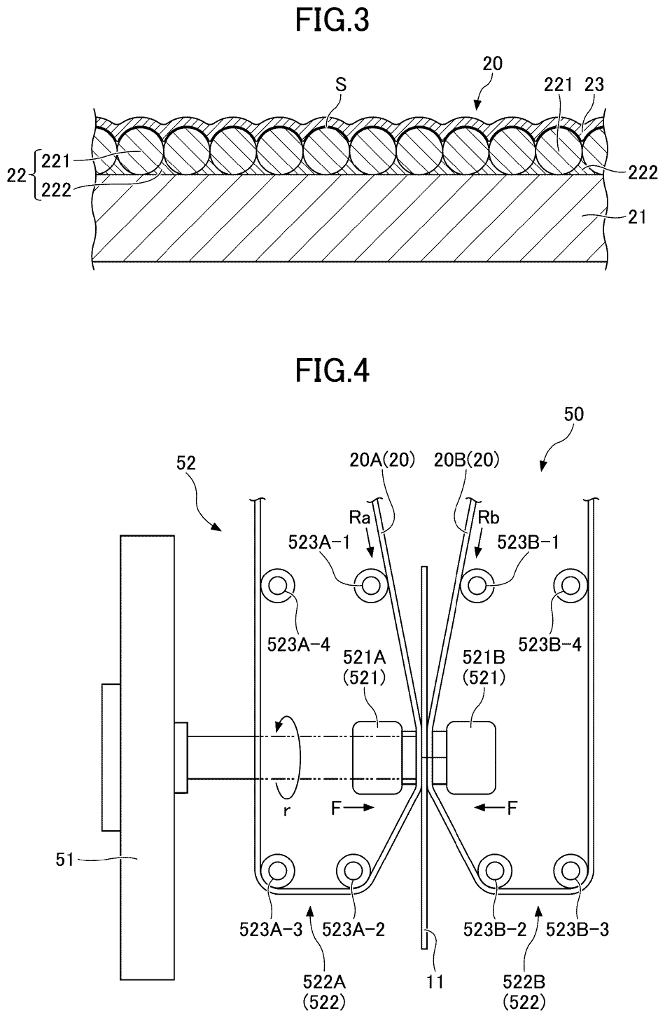

FIG. 3 is an enlarged cross-sectional diagram illustrating an example of the abrasive tape 20 used for burnishing. As illustrated in FIG. 3, the abrasive tape 20 abrades the stack 11 by sliding an abrasion surface S over the surface of the stack 11.

The abrasive tape 20 includes an abrasive layer 22 on a support 21. The abrasive layer 22 includes abrasive grains 221 and a binder 222. The binder 222 binds the abrasive grains 221 to each other, and binds the abrasive grains 221 to the support 21. Also, the binder 222 sticks the abrasive grains 221 to the abrasive layer 22.

No particular limitation is imposed on the material forming the support 21, and various resins, such as polyethylene terephthalate, are used.

The abrasive grains 221 can be used as an abrasive included in the abrasive tape 20. Examples of the abrasive grains 221 include grains containing chromium oxide, α-alumina, silicon carbide, non-magnetic iron oxide, diamond, γ-alumina, α, γ-alumina, fused alumina, corundum, artificial diamond, or the like. The abrasive grains 221 may be grains formed of any one of these materials, or may be grains formed of two or more of these materials that are appropriately combined.

No particular limitation is imposed on the binder 222, and a thermosetting resin, a thermoplastic resin, a photosensitive resin, or the like can be used. The resins used as the binder 222 may be used alone or in combination.

Also, a lubricating film 23 may be provided at the surface of the abrasion surface S.

FIG. 4 is a diagram illustrating an example of a burnishing apparatus used in the burnishing step of burnishing the surface of the stack 11 with an abrasive. As illustrated in FIG. 4, a burnishing apparatus 50 includes: a set of abrasive tapes 20 (abrasive tapes 20A and 20B) that are disposed to face each other so as to sandwich the stack 11 from both surfaces of the stack 11; a rotation support 51; and a tape moving unit 52. In the burnishing apparatus 50, the abrasive tapes 20A and 20B are disposed to face each other so as to sandwich the stack 11 from both surfaces of the stack 11, and thus it is possible to perform the burnishing on both surfaces of the stack 11 simultaneously and efficiently.

The rotation support 51 is configured to rotate the stack 11 in a circumferential direction (direction indicated by an arrow r) while supporting a center opening of the stack 11.

The tape moving unit 52 is configured to move the abrasive tapes 20A and 20B in the radial direction of the stack 11 relative to the stack 11 while pressing the abrasive tapes 20A and 20B against both surfaces of the rotating stack 11 in directions indicated by arrows F.

The tape moving unit 52 includes: a pair of abrasive tape pressing members 521, which are disposed to face each other so as to sandwich the stack 11 from both surfaces of the stack 11 through the abrasive tapes 20A and 20B; and a pair of abrasive tape drive systems 522, which are disposed to face each other so as to sandwich the stack 11 from both surfaces of the stack 11 through the abrasive tapes 20A and 20B.

The pair of abrasive tape pressing members 521 include a first abrasive tape pressing member 521A and a second abrasive tape pressing member 521B. The pair of abrasive tape drive systems 522 include a first abrasive tape drive system 522A and a second abrasive tape drive system 522B.

That is, the tape moving unit 52 includes: the first abrasive tape pressing unit 521A and the first abrasive tape drive system 522A, which are disposed on one side across the stack 11; and the second abrasive tape pressing unit 521B and the second abrasive tape drive system 522B, which are disposed on the other side.

The first abrasive tape drive system 522A includes a supply roller and a winding roller (both are not shown) and first guide rollers 523A-1 to 523A-4 disposed below the supply roller and the winding roller, and is configured to move the abrasive tape 20A in a direction indicated by an arrow Ra.

The second abrasive tape drive system 522B includes a supply roller and a winding roller (both are not shown) and second guide rollers 523B-1 to 523B-4 disposed below the supply roller and the winding roller, and is configured to move the abrasive tape 20B in a direction indicated by an arrow Rb.

### [Removal Step]

Next, as illustrated in FIG. 2, the second lubricant 122 over the stack 11 is removed (removal step).

The removal step includes the LED light irradiation step of irradiating the stack 11, the surface of which the first lubricant 121 and the second lubricant 122 are applied to, with the light emitted from the LED light source. By irradiating the second lubricant 122 over the stack 11 with the LED light 30 emitted from the LED light source, the second lubricant 122 over the stack 11 is removed. Thus, the first lubricant 121 remains on the surface of the protective layer 113 of the stack 11, and the remaining first lubricant 121 becomes the lubricating layer 12 of the magnetic recording medium 1.

In the LED light irradiation step, preferably, the second lubricant 122 is completely removed. However, a portion of the second lubricant 122 may remain.

The LED light 30 emitted from the LED light source tends to be parallel light. Thus, spreading of the LED light 30 to the surroundings can be suppressed, and only the second lubricant 122 over the stack 11 can be efficiently heated and decomposed and can be removed under conditions that the second lubricant 122 can be gasified.

The center wavelength of the LED light 30 is preferably less than 500 nm. The LED light 30 having the center wavelength of less than 500 nm readily gasifies and decomposes organic compounds typically used as lubricants. Therefore, when the center wavelength of the LED light 30 is less than 500 nm, the conditions of the LED light 30 for gasifying the second lubricant 122 without gasifying the first lubricant 121 can be readily selected.

Preferably, the center wavelength of the LED light 30 does not include a wavelength range of 170 nm to 190 nm. The light having a center wavelength in the wavelength range of 170 nm to 190 nm often decomposes oxygen to generate ozone. In the production of the magnetic recording medium 1, ozone decomposes environmental substances or the like, and the decomposed substances may adhere to the surface of the magnetic recording medium 1 as contaminants. However, the LED light 30 having a center wavelength not including the wavelength range of 170 nm to 190 nm can suppress generation of ozone.

Also, by using the LED light source configured to emit the LED light 30 having the center wavelength as described above, the LED light irradiation step can be performed in the atmosphere, i.e., under a pressure close to the atmospheric pressure or in an open-air atmosphere, and the LED light irradiator becomes simplified. This can reduce the production cost of the magnetic recording medium 1 and the production cost of the LED light irradiator.

In the magnetic recording medium production method of the present embodiment, the LED light irradiation step is preferably performed within 60 seconds, and more preferably within 20 seconds. By reducing the treatment time in this manner, it is possible to reduce the production cost of the magnetic recording medium 1, and the risk of contamination of the magnetic recording medium 1 during the treatment.

### (LED Light Irradiator)

An example of the LED light irradiator used in the removal step of the magnetic recording medium production method according to the present embodiment will be described. FIG. 5 is a cross-sectional schematic diagram illustrating an example of the LED light irradiator used in the removal step of the magnetic recording medium production method according to the present embodiment. As illustrated in FIG. 5, an LED light irradiator 60 includes: a first LED light source 62 configured to emit (radiate) LED light (first LED light) to one surface (treatment surface) 61a of a substrate 61, thereby treating the substrate 61; a second LED light source 63 configured to emit LED light (second LED light) to the other surface (treatment surface) 61b of the substrate 61, thereby heating the substrate 61; and a mechanism 65 configured to support an outer circumferential end 61c of the substrate 61 by a support 64, and transfer the substrate 61 between the first LED light source 62 and the second LED light source 63. In FIG. 5, the mechanism 65 configured to transfer the substrate 61 and the support 64 has the function of vertically raising and lowering the substrate 61 as indicated by a double arrow.

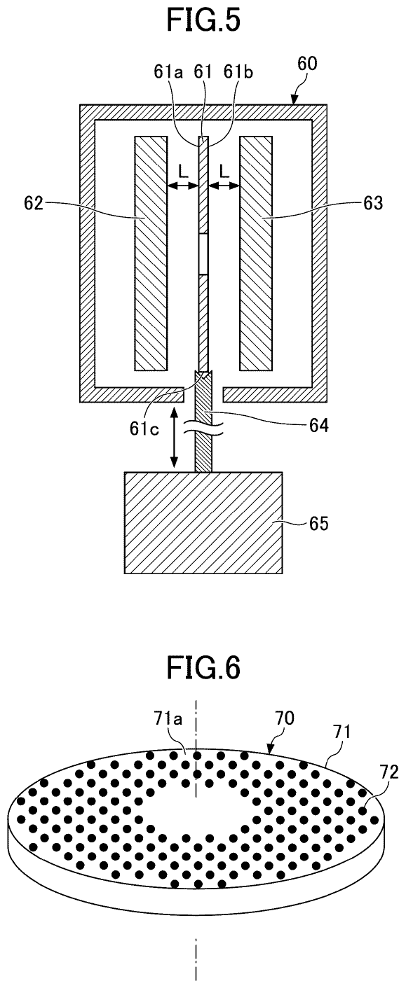

FIG. 6 is a perspective schematic diagram illustrating an example of a light source of the LED light irradiator 60. As illustrated in FIG. 6, an LED light source 70 forming the first LED light source 62 and the second LED light source 63 includes numerous LED elements 72 attached to a body 71 of the LED light source 70. The numerous LED elements 72 attached to the body 71 of the LED light source 70 are disposed to face the two treatment surfaces 61a and 61b of the substrate 61 illustrated in FIG. 5.

Each of the LED elements 72 is disposed to cause emitted light to have directivity with a center axis being a direction perpendicular to a main surface 71a of the body 71 of the LED light source 70. The directivity of the LED element 72 is preferably ±60° or less relative to the center axis.

Here, an angle of the directivity of the LED element 72 is defined as follows with a position at which the LED element 72 light is the strongest being the center axis. Specifically, the angle of the directivity of the LED element 72 is defined as an angle relative to the center axis when illuminance is 50% in a case in which illuminance at the center axis is 100%. Note that there is an opening at the center of the substrate 61 illustrated in FIG. 5, and thus the LED light source 70 does not need to include the LED elements 72 near the center of the body 71.

As described above, the LED light irradiator 60 includes the first LED light source 62 and the second LED light source 63, and uses the LED light source 70 having the configuration illustrated in FIG. 6 as the first LED light source 62 and the second LED light source 63. This configuration can treat both surfaces (treatment surfaces 61a and 61b) of the substrate 61 at a high speed. Therefore, by using the magnetic recording medium 1 as the substrate 61, the LED light irradiator 60 can treat both surfaces of the magnetic recording medium 1 at a high speed, and increase the productivity of the magnetic recording medium 1.

In the LED light irradiator 60, preferably, the substrate 61 is directly irradiated with 50% or more of the LED light emitted from the first LED light source 62 and the second LED light source 63. According to the LED light irradiator 60 having this configuration, the LED light emitted from the first LED light source 62 and the second LED light source 63 can be focused on the substrate 61, i.e., it is possible to avoid irradiating any member other than the substrate 61 with the LED light. Thus, it is possible to increase the treatment speed, and suppress generation of impurities.

In the LED light irradiator 60, a distance L between the substrate 61, and the first LED light source 62 or the second LED light source 63 is preferably 50 mm or less. According to the LED light irradiator 60 having this configuration, the LED light emitted from the first LED light source 62 and the second LED light source 63 can be focused on the substrate 61, and thus it is possible to increase the treatment speed.

In the LED light irradiator 60, preferably, the center wavelength of the LED light emitted from the first LED light source 62 and the second LED light source 63 is less than 500 nm, and the center wavelength does not include the wavelength range of 170 nm to 190 nm. When the center wavelength of the LED light emitted from the first LED light source 62 and the second LED light source 63 is less than 500 nm, the conditions for gasifying only the second lubricant 122 can be readily selected. Also, when the center wavelength of the LED light emitted from the first LED light source 62 and the second LED light source 63 does not include the wavelength range of 170 nm to 190 nm, it is possible to suppress decomposition of oxygen to generate ozone.

Only in a case in which the substrate 61 is disposed between the first LED light source 62 and the second LED light source 63, the LED light irradiator 60 preferably includes a controller configured to control emission of light from the first LED light source 62 and the second LED light source 63. Note that the case in which the substrate 61 is disposed between the first LED light source 62 and the second LED light source 63 refers to a case in which the substrate 61 is in a state illustrated in FIG. 5.

According to the LED light irradiator 60 having this configuration, heat generated when the LED light from one of the first LED light source 62 or the second LED light source 63 is applied to the other of the first LED light source 62 or the second LED light source 63 can be substantially prevented from degrading the other LED light source. Also, when the first LED light source 62 and the second LED light source 63 are caused to emit light only during the treatment, the LED light irradiator 60 can realize long lifetimes of the first LED light source 62 and the second LED light source 63, and can reduce power used by the LED light irradiator 60.

As described above, the magnetic recording medium production method according to the present embodiment includes the application step, the burnishing step, and the removal step. The burnishing step includes the abrasion step of abrading the surface of the stack 11 by pressing the abrasive tape 20 against the surface of the stack 11. The removal step includes the LED light irradiation step of irradiating the stack 11, to which the first lubricant 121 and the second lubricant 122 are applied, with the LED light 30. The removal step can remove the second lubricant 122 by the LED light 30 emitted from the LED light source, and can form the first lubricant 121 as the lubricating layer 12. Thus, it is possible to increase the lubricating layer 12 covering rate of the stack 11, and reduce the amount of foreign matter generated at the surface of the lubricating layer 12. Therefore, according to the magnetic recording medium production method according to the present embodiment, it is possible to efficiently remove foreign matter at the surface of the magnetic recording medium 1, and produce the magnetic recording medium having the lubricating layer 12 covering rate that is high.

As described above, the magnetic recording medium 1 produced by the magnetic recording medium production method according to the present embodiment has a small amount of foreign matter at the surface of the magnetic recording medium 1, and has the lubricating layer 12 covering rate that is high. Thus, it is possible to suppress damage due to abrasion caused by sliding of the magnetic recording medium 1 in contact with the magnetic head, and enhance durability. The magnetic recording medium 1 can maintain excellent electromagnetic conversion characteristics, and stably have a high recording density. Thus, the magnetic recording medium 1 is suitably used for a magnetic recording and reproducing device. No particular limitation is imposed on a form of the magnetic recording and reproducing device as long as the magnetic recording and reproducing device includes a magnetic recording medium produced by the magnetic recording medium production method according to the present embodiment. The magnetic recording and reproducing device may be, for example, a magnetic recording and reproducing device configured to record magnetic information in the magnetic recording medium by a heat-assisted recording method.

In the present embodiment, the magnetic recording medium may include, between the substrate 111 and the magnetic recording layer 112, one or more selected from an adhesion layer, a soft magnetic base layer, a seed layer, and an orientation control layer. One or more of any of these layers may be stacked.

In the present embodiment, the magnetic recording medium may include a plurality of magnetic recording layers that are stacked. In this case, a non-magnetic recording layer may be provided between any adjacent magnetic recording layers of the plurality of magnetic recording layers.

Although the embodiments of the present invention have been described above, the above embodiments are presented just as examples, and the present invention is not limited to the above embodiments. The above embodiments can be implemented in various other forms, and various combinations, omissions, substitutions, modifications, and the like are possible without departing from the intent of the present invention. These embodiments and modifications thereof are included in the scope and intent of the present invention, and are also included in the scope of the inventions recited in claims and in the scope of equivalents thereof.

### EXAMPLES

Hereinafter, the present embodiment will be described in more detail by way of examples, but the present embodiment is not limited to the examples.

### Example 1

### [Production of Magnetic Recording Medium]

A cleaned glass substrate (outer profile: 2.5 inches (about 6.35 cm), obtained from HOYA Corporation) was housed in a film-forming chamber of a DC magnetron sputtering apparatus (C-3040, obtained from ANELVA Corporation). The interior of the film-forming chamber was evacuated until the highest reachable degree of vacuum, i.e., 1×10⁻⁵ Pa. Subsequently, an adhesion layer having a layer thickness of 10 nm was formed over the glass substrate through sputtering using a Cr target.

Next, a soft magnetic base layer was formed over the adhesion layer through sputtering. As the soft magnetic base layer, a first soft magnetic recording layer, an intermediate layer, and a second soft magnetic recording layer were sequentially formed. First, a first soft magnetic recording layer having a layer thickness of 25 nm was formed using a target of Co-20Fe-5Zr-5Ta {Fe content: 20 atomic %, Zr content: 5 atomic %, Ta content: 5 atomic %, and balance: Co} at a substrate temperature of 100° C. or lower. Next, an intermediate layer formed of Ru having a layer thickness of 0.7 nm was formed. Subsequently, a second soft magnetic recording layer formed of Co-20Fe-5Zr-5Ta having a layer thickness of 25 nm was formed.

Next, a seed layer having a layer thickness of 5 nm was formed over the soft magnetic base layer using an Ni-6W {W content: 6 atomic % and balance: Ni} target through sputtering.

Subsequently, an Ru layer having a layer thickness of 10 nm was formed over the seed layer as a first orientation control layer through sputtering at a sputtering pressure of 0.8 Pa.

Next, an Ru layer having a layer thickness of 10 nm was formed over the first orientation control layer as a second orientation control layer through sputtering at a sputtering pressure of 1.5 Pa.

Subsequently, a first magnetic recording layer formed of 91 (Co15Cr16Pt)-6(SiO₂)-3(TiO₂) {Cr content: 15 atomic %, Pt content: 16 atomic %, Co alloy as balance: 91 mol %, SiO₂: 6 mol %, and TiO₂: 3 mol %} was formed over the second orientation control layer through sputtering to have a layer thickness of 9 nm. The sputtering pressure was set to 2 Pa.

Next, a non-magnetic recording layer formed of 88(Co30Cr)-12(TiO₂) {Cr content: 30 atomic %, Co alloy as balance: 88 mol %, and TiO₂: 12 mol %} was formed over the first magnetic recording layer through sputtering to have a layer thickness of 0.3 nm.

Subsequently, a second magnetic recording layer formed of 92(Co11Cr18Pt)-5(SiO₂)-3(TiO₂) {Cr content: 11 atomic %, Pt content: 18 atomic %, Co alloy as balance: 92 mol %, SiO₂: 5 mol %, and TiO₂: 3 mol %} was formed over the non-magnetic recording layer through sputtering to have a layer thickness of 6 nm. The sputtering pressure was 2 Pa.

Subsequently, a non-magnetic recording layer formed of Ru was formed over the second magnetic recording layer through sputtering to have a layer thickness of 0.3 nm.

Next, a third magnetic recording layer was formed over the non-magnetic recording layer to have a layer thickness of 7 nm through sputtering using a target of Co-20Cr-14Pt-3B {Cr content: 20 atomic %, Pt content: 14 atomic %, B content: 3 atomic %, and balance: Co} at a sputtering pressure of 0.6 Pa.

Using gasified toluene as a raw material gas, a hydrogenated carbon film was formed over the surface of the third magnetic recording layer through ion beam deposition. For the formation of the hydrogenated carbon film, first, the gas flow rate of the raw material gas to be supplied into the film-forming chamber was set to 2.9 SCCM, and the reaction pressure was set to 0.2 Pa. Also, cathode power, serving as an excitation source of the raw material gas, was set to 225 W (AC 22.5 V, 10 A). The hydrogenated carbon film was formed to have a thickness of 3.5 nm under conditions that a voltage between a cathode electrode and an anode electrode covering the cathode electrode was 75 V, a current between the cathode electrode and the anode electrode covering the cathode electrode was 1, 650 mA, an ion acceleration voltage was 200 V, an ion current was 180 mA, and a time for film formation was 1.5 seconds. After the formation of the hydrogenated carbon film, the supply of the raw material gas was stopped, and the film-forming chamber was evacuated for 2 seconds.

Next, a nitrogen gas was supplied into the film-forming chamber at a gas flow rate of 2 SCCM and at a reaction pressure of 5 Pa. The surface of the hydrogenated carbon film was irradiated with nitrogen ions formed from the nitrogen gas and exposed to a nitrogen plasma under conditions that the cathode power was 128 W (AC 16 V, 8 A), the voltage between the cathode electrode and the anode electrode was 75 V, the current was 1,000 mA, the ion acceleration voltage was 200 V, the current was 90 mA, and the treatment time was one second. Thus, the surface of the hydrogenated carbon film was dehydrogenated and nitrogenated, and the nitrogenated carbon film was formed as a protective layer.

Next, D5OH(XS) (product name, obtained from MORESCO Corporation) of structural formula (i) below, serving as the first lubricant, was dissolved in Vertrel XF (product name, obtained from Chemours-Mitsui Fluoroproducts Co., Ltd.) to obtain a first lubricating layer forming solution. The concentration of the compound contained in the first lubricating layer forming solution was 0.3% by mass.

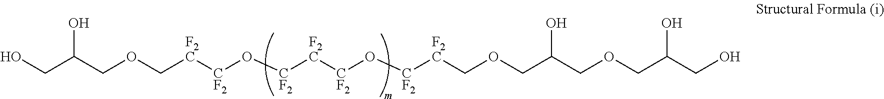

In the structural formula (i), m is a positive integer.

Next, the first lubricating layer forming solution was applied to the protective layer through dipping. Specifically, the stack, in which the layers up to the protective layer were formed, was dipped in the first lubricating layer forming solution placed in a dip tank of a dip coat apparatus, and then the stack was pulled up from the dip tank at a constant speed. In this manner, the first lubricating layer forming solution was applied to the surface of the protective layer such that the layer thickness of the first lubricating layer would be 7 Å. Subsequently, the surface of the stack, to which the first lubricating layer forming solution was applied, was dried to form a first lubricating layer over the surface of the stack.

Next, the second lubricant of structural formula (ii) below was dissolved in HFE7200 (product name, obtained from 3M) to obtain a second lubricating layer forming solution. The concentration of the compound contained in the second lubricating layer forming solution was 0.3% by mass. Note that HFE7200 can dissolve the second lubricant of the structural formula (ii), but cannot dissolve the first lubricant D5OH(XS).

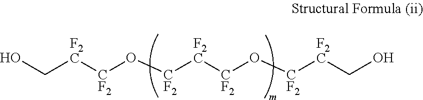

In the structural formula (ii), m is a positive integer.

Next, a second lubricant was applied through dipping to the surface of the stack in which the first lubricating layer was formed. The layer thickness of the second lubricating layer was 7 Å. Subsequently, by drying the surface to which the second lubricating layer forming solution was applied, a second lubricating layer was formed over the surface of the stack in which the first lubricating layer was formed.

Next, the surface of the stack, in which the first lubricating layer and the second lubricating layer were formed, was burnished with an abrasive tape. This abrasive tape used, as an abrasive, model number DQ3 obtained from Sumitomo 3M using Al₂O₃ having a particle diameter of 0.3 μm. Conditions for the burnishing were that the rotation speed of the stack was 1,000 rpm and the treatment time was 3 seconds.

Next, the surface of the stack, in which the first lubricating layer and the second lubricating layer were formed, was irradiated with LED light from an LED light source. As an irradiator, the LED light irradiator illustrated in FIG. 5 was used. As an LED light source, the LED light source illustrated in FIG. 6 was used. A magnetic recording medium was produced under conditions that the center wavelength of the LED light source was 395 nm (not including light having a center wavelength of 500 nm or more), an irradiation area (light-emitting area) was 100 mm in diameter (effective area), a light intensity within the effective area was 11 W/cm², and evenness of the light intensity in the effective area was within ±7%. By irradiating the surface of the stack, in which the first lubricating layer and the second lubricating layer were formed, with LED light, the second lubricating layer was removed from the surface of the first lubricating layer, thereby forming a lubricating layer formed of the first lubricating layer.

The above process produced a magnetic recording medium in which the adhesion layers, the soft magnetic base layers, the seed layers, the first orientation control layers, the second orientation control layers, the first magnetic recording layers, the non-magnetic recording layers, the second magnetic recording layers, the non-magnetic recording layers, the third magnetic recording layers, the carbon nitride films (protective layers), and the lubricating layers were sequentially stacked respectively over both surfaces of the glass substrate.

### [Evaluation of Lubricating Layer]

The stack after the LED irradiation and the heating was analyzed through ESCA. It was confirmed based on this analysis that the first lubricating layer having a layer thickness of 7 Å remained, and the second lubricating layer was removed.

### (Lubricating Layer Covering Rate)

The lubricating layer covering rate of the produced magnetic recording medium was measured in the following manner. Specifically, the magnetic recording medium in which the lubricating layer was formed was dipped in a fluorocarbon solvent for 5 minutes. The same medium was measured at the same position through ESCA for an absorbance around 1,270 cm⁻¹ before and after dipping. A percentage of a ratio, i.e., absorbance after dipping/absorbance before dipping×100, was measured as the lubricating layer covering rate. The fluorocarbon solvent used was Vertrel XF (product name, obtained from Chemours-Mitsui Fluoroproducts Co., Ltd.). The lubricating layer covering rate of the produced magnetic recording medium was 81%.

### (Thermal Asperity (TA) Glide Evaluation)

TA glide evaluation of the produced magnetic recording medium was performed. An MR head (obtained from TDK Corporation) was used as an inspection head for the TA glide evaluation. The TA glide evaluation is a method of detecting a phenomenon in which a signal waveform reproduced by the MR head fluctuates due to frictional heat generated when the MR head collides with projections at the surface of the magnetic recording medium, i.e., thermal asperity TA, thereby evaluating smoothness of the surface of the magnetic recording medium from the number of generated signals (TA count). The smaller the TA count, the higher the smoothness of the surface of the magnetic recording medium. The TA counts of the one-hundred produced magnetic recording media were six per surface on average.

Preparation conditions for the first lubricating layer and the second lubricating layer are shown in Tables 1-1 and 1-2. Treatment conditions for the first lubricant and the second lubricant, and the evaluation results of the lubricating layers, are shown in Tables 2-1 and 2-2.

### Examples 2 to 8 and Comparative Examples 1 to 8

Magnetic recording media were produced in the same manner as in Example 1 except that the preparation conditions for the first lubricating layer and the second lubricating layer were changed to values shown in Tables 1-1 and 1-2, and the treatment conditions for the first lubricant and the second lubricant were changed to values shown in Tables 2-1 and 2-2. The lubricating layers of the produced magnetic recording media were evaluated in the same manner as in Example 1. The preparation conditions for the first lubricating layer and the second lubricating layer are shown in Tables 1-1 and 1-2. The treatment conditions for the first lubricant and the second lubricant, and the evaluation results of the lubricating layers, are shown in Tables 2-1 and 2-2.

In Comparative Examples 1 to 8, magnetic recording media were produced in the same manner as in Examples 1 to 8 except that UV irradiation from an ultraviolet lamp (obtained from Ushio Inc.) and heating were used for removal of the second lubricating layer. The UV irradiation from the ultraviolet lamp was performed for 10 seconds in a nitrogen gas atmosphere, and the heating was performed at 120° C. for 1,200 seconds in a nitrogen gas atmosphere.

D4OH and D4OH(s) (both are product names, obtained from MORESCO Corporation) used as the first lubricant in any one of Examples 2 to 8 and Comparative Examples 1 to 8 have structural formula (iii) below, and the second lubricant used in any one of Examples 2 to 8 and Comparative Examples 1 to 8 has structural formula (iv) below. The average molecular weight of D4OH was adjusted to 2,000, and the average molecular weight of D4OH(s) was adjusted to 1,600. In the same manner as in Example 1, HFE7200 (product name, obtained from 3M) was used as the solvent of the second lubricant. HFE7200 can dissolve the second lubricant but cannot dissolve the first lubricant.

Structural formulae of D4OH and D4OH(s):

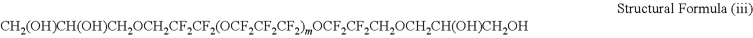

In the structural formula (iii), m is a positive integer.

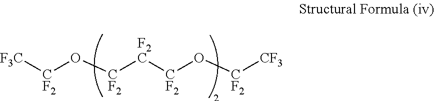

TABLE 1-1

| | Preparation conditions for first lubricating layer and second lubricating layer | | | | | | | |
|---|---|---|---|---|---|---|---|---|
| | First lubricating layer | | | | Second lubricating layer | | | |
| | First lubricant | | | | Second lubricant | | | |
| | | Average | Number of | Layer | | Average | Number of | Layer |
| | | molecular | polar | thickness | | molecular | hydroxy | thickness |
| | Type | weight | groups | [Å] | Type | weight | groups | [Å] |
| Ex. 1 | D5OH(XS) | 1300 | 5 | 7 | Structural | 600 | 2 | 7 |
| | | | | | Formula (ii) | | | |
| Ex. 2 | D5OH(XS) | 1300 | 5 | 7 | Structural | 600 | 0 | 7 |
| | | | | | Formula (iv) | | | |
| Ex. 3 | D4OH(s) | 1600 | 4 | 7 | Structural | 600 | 0 | 7 |
| | | | | | Formula (iv) | | | |
| Ex. 4 | D4OH | 2000 | 4 | 7 | Structural | 600 | 0 | 7 |
| | | | | | Formula (iv) | | | |
| Ex. 5 | D5OH(XS) | 1300 | 5 | 5 | Structural | 600 | 0 | 7 |
| | | | | | Formula (iv) | | | |
| Ex. 6 | D5OH(XS) | 1300 | 5 | 10 | Structural | 600 | 0 | 7 |
| | | | | | Formula (iv) | | | |
| Ex. 7 | D5OH(XS) | 1300 | 5 | 7 | Structural | 600 | 0 | 2 |
| | | | | | Formula (iv) | | | |
| Ex. 8 | D5OH(XS) | 1300 | 5 | 7 | Structural | 600 | 0 | 20 |
| | | | | | Formula (iv) | | | |

TABLE 1-2
Preparation conditions for first lubricating layer and second lubricating layer

| | First lubricating layer | | | | Second lubricating layer | | | |
|---|---|---|---|---|---|---|---|---|
| | First lubricant | | | | Second lubricant | | | |
| | | Average | Number of | Layer | | Average | Number of | Layer |
| | | molecular | polar | thickness | | molecular | hydroxy | thickness |
| | Type | weight | groups | [Å] | Type | weight | groups | [Å] |
| Comp. Ex. 1 | D5OH(XS) | 1300 | 5 | 7 | Structural | 600 | 2 | 7 |
| | | | | | Formula (ii) | | | |
| Comp. Ex. 2 | D5OH(XS) | 1300 | 5 | 7 | Structural | 600 | 0 | 7 |
| | | | | | Formula (iv) | | | |
| Comp. Ex. 3 | D4OH(s) | 1600 | 4 | 7 | Structural | 600 | 0 | 7 |
| | | | | | Formula (iv) | | | |
| Comp. Ex. 4 | D4OH | 2000 | 4 | 7 | Structural | 600 | 0 | 7 |
| | | | | | Formula (iv) | | | |
| Comp. Ex. 5 | D5OH(XS) | 1300 | 5 | 5 | Structural | 600 | 0 | 7 |
| | | | | | Formula (iv) | | | |
| Comp. Ex. 6 | D5OH(XS) | 1300 | 5 | 10 | Structural | 600 | 0 | 7 |
| | | | | | Formula (iv) | | | |
| Comp. Ex. 7 | D5OH(XS) | 1300 | 5 | 7 | Structural | 600 | 0 | 2 |
| | | | | | Formula (iv) | | | |
| Comp. Ex. 8 | D5OH(XS) | 1300 | 5 | 7 | Structural | 600 | 0 | 20 |
| | | | | | Formula (iv) | | | |

TABLE 2-1

| | Treatment conditions for first lubricating layer | | | | Evaluation results of lubricating | | |
|---|---|---|---|---|---|---|---|
| | and second lubricating layer | | | | layers | | |
| | | | | | Evaluation of lubricating | | |
| | Light irradiation | | Heating | | layers | Lubricating layer | TA count |
| | Irradiation | Time | Temperature | Time | First lubricating layer/ | covering rate | (number/ |
| | source | [sec] | [° C.] | [sec] | Second lubricating layer | [%] | surface) |
| Ex. 1 | LED light | 4 | None | — | Remained/Removed | 81 | 6 |
| | source | | | | | | |
| Ex. 2 | LED light | 4 | None | — | Remained/Removed | 82 | 4 |
| | source | | | | | | |
| Ex. 3 | LED light | 4 | None | — | Remained/Removed | 80 | 4 |
| | source | | | | | | |
| Ex. 4 | LED light | 4 | None | — | Remained/Removed | 80 | 5 |
| | source | | | | | | |
| Ex. 5 | LED light | 4 | None | — | Remained/Removed | 75 | 8 |
| | source | | | | | | |
| Ex. 6 | LED light | 4 | None | — | Remained/Removed | 86 | 4 |
| | source | | | | | | |
| Ex. 7 | LED light | 4 | None | — | Remained/Removed | 82 | 8 |
| | source | | | | | | |
| Ex. 8 | LED light | 4 | None | — | Remained/Removed | 81 | 4 |
| | source | | | | | | |

TABLE 2-2

| | Treatment conditions for first lubricating layer | | | | Evaluation results of lubricating | | |
|---|---|---|---|---|---|---|---|
| | and second lubricating layer | | | | layers | | |
| | | | | | Evaluation of lubricating | | |
| | Light irradiation | | Heating | | layers | Lubricating layer | TA count |
| | Irradiation | Time | Temperature | Time | First lubricating layer/ | covering rate | (number/ |
| | source | [sec] | [° C.] | [sec] | Second lubricating layer | [%] | surface) |
| Comp. Ex. 1 | UV lamp | 10 | 120 | 1200 | Remained/Removed | 80 | 7 |
| Comp. Ex. 2 | UV lamp | 10 | 120 | 1200 | Remained/Removed | 80 | 5 |
| Comp. Ex. 3 | UV lamp | 10 | 120 | 1200 | Remained/Removed | 78 | 5 |
| Comp. Ex. 4 | UV lamp | 10 | 120 | 1200 | Remained/Removed | 78 | 7 |
| Comp. Ex. 5 | UV lamp | 10 | 120 | 1200 | Remained/Removed | 74 | 10 |
| Comp. Ex. 6 | UV lamp | 10 | 120 | 1200 | Remained/Removed | 85 | 5 |
| Comp. Ex. 7 | UV lamp | 10 | 120 | 1000 | Remained/Removed | 80 | 10 |
| Comp. Ex. 8 | UV lamp | 10 | 120 | 1800 | Remained/Removed | 80 | 5 |

In Tables 1-1 and 1-2 and Tables 2-1 and 2-2, “Ex.” and “Comp. Ex.” stand for “Example” and “Comparative Example”, respectively. According to Tables 2-1 and 2-2, the lubricating layer covering rate was higher in Examples 1 to 8 than in Comparative Examples 1 to 8 corresponding to Examples 1 to 8, and the TA count was lower in Examples 1 to 8 than in Comparative Examples 1 to 8 corresponding to Examples 1 to 8. Therefore, by using the magnetic recording medium production method according to the present embodiment in which the second lubricant is irradiated with LED light to remove the second lubricant, thereby forming the lubricating layer formed of the first lubricant, it is possible to efficiently remove foreign matter at the surface of the magnetic recording medium, and obtain the magnetic recording medium having the lubricating layer covering rate that is high.

As described above, according to the aspect of the present disclosure, it is possible to provide a magnetic recording medium production method that can efficiently remove foreign matter at the surface of a magnetic recording medium, and can produce a magnetic recording medium having a lubricating layer covering rate that is high.

What is claimed is:

1. A magnetic recording medium production method which includes forming a lubricating layer over a stack including a substrate, a magnetic recording layer over the substrate, and a protective layer over the magnetic recording layer, the magnetic recording medium production method comprising:
applying a first lubricant and a second lubricant to the stack;
burnishing, with an abrasive, a surface of the stack to which the first lubricant and the second lubricant are applied; and
removing the second lubricant over the stack, wherein
the burnishing includes abrading the surface of the stack by pressing a tape containing the abrasive against the surface of the stack, and
the removal of the second lubricant includes irradiating the stack, to which the first lubricant and the second lubricant are applied, with light emitted from an LED light source.

2. The magnetic recording medium production method according to claim 1, wherein
a center wavelength of the light emitted from the LED light source is less than 500 nm, and
the center wavelength of the light does not include a wavelength range of 170 nm to 190 nm.

3. The magnetic recording medium production method according to claim 1, wherein
the irradiation of the stack with the light emitted from the LED light source is performed under a pressure close to an atmospheric pressure.

4. The magnetic recording medium production method according to claim 1, wherein
an average molecular weight of the first lubricant is higher than an average molecular weight of the second lubricant, and
polarity of the first lubricant is higher than polarity of the second lubricant.

5. The magnetic recording medium production method according to claim 4, wherein
the average molecular weight of the second lubricant is 300 to 1,000, and
the second lubricant includes two or fewer polar groups, or does not include polar groups.

6. The magnetic recording medium production method according to claim 4, wherein
the average molecular weight of the first lubricant is 900 to 3,000, and
the first lubricant includes four to eight polar groups.

7. The magnetic recording medium production method according to claim 1, wherein
a film thickness of the first lubricant applied to the stack is 5 angstroms to 10 angstroms, and
a film thickness of the second lubricant applied to the stack is 5 angstroms to 20 angstroms.
